(19) United States
(12) Patent Application Publication
(10) Pub. No.: US 2024/0156175 A1
(43) Pub. Date: May 16, 2024

(54) BATTERY ASSEMBLY, VAPORIZER, AND ELECTRONIC VAPORIZATION DEVICE

(71) Applicant: SHENZHEN SMOORE TECHNOLOGY LIMITED, Shenzhen (CN)

(72) Inventor: Wenjie DONG, Shenzhen (CN)

(21) Appl. No.: 18/421,310

(22) Filed: Jan. 24, 2024

Related U.S. Application Data
(63) Continuation of application No. PCT/CN2021/109329, filed on Jul. 29, 2021.

(51) Int. Cl. A24F 40/65; A24F 40/50; H01M 10/42; H02J 7/00

(52) U.S. Cl. CPC A24F 40/65; A24F 40/50; H01M 10/425; H02J 7/00032; H02J 7/0063; H02J 7/00711; H01M 2010/4278; H01M 2220/30

(57) ABSTRACT

A battery assembly includes: a positive voltage terminal and a negative voltage terminal, the battery assembly being connected to a vaporizer by the positive voltage terminal and the negative voltage terminal so as to supply power to the vaporizer; and a control circuit connected to at least one of the positive voltage terminal and the negative voltage terminal so as to use the connected positive voltage terminal or negative voltage terminal as a communication terminal to implement transmission of a communication signal with the vaporizer. The communication signal includes a plurality of spike signals superimposed based on a corresponding working voltage the communication terminal needs to output or a pulse width modulation signal generated by modulating the corresponding working voltage the communication terminal needs to output.

### CROSS-REFERENCE TO PRIOR APPLICATION

This application is a continuation of International Patent Application No. PCT/CN2021/109329, filed on Jul. 29, 2021. The entire disclosure is hereby incorporated by reference herein.

### FIELD

This application relates to the field of vaporization technologies, and in particular, to a battery assembly, a vaporizer, and an electronic vaporization device.

### BACKGROUND

An existing electronic vaporization device with an encryption function includes a battery assembly and a vaporizer. The battery assembly is electrically connected to the vaporizer. The battery assembly supplies power to the vaporizer, to enable the vaporizer to vaporize a to-be-vaporized substrate. To implement the encryption function, the electronic vaporization device usually uses two constant voltages. That is, a high level and a low level (ground level) are combined to form a communication signal with a fixed frequency, to implement communication between the battery assembly and the vaporizer. However, in a communication process, the communication signal that has a fixed frequency and that is formed by combining a high level and a low level is prone to interference of an external signal, resulting in poor communication or even a matching failure between the battery assembly and the vaporizer.

### SUMMARY

In an embodiment, the present invention provides a battery assembly, comprising: a positive voltage terminal and a negative voltage terminal, the battery assembly being connected to a vaporizer by the positive voltage terminal and the negative voltage terminal so as to supply power to the vaporizer; and a control circuit connected to at least one of the positive voltage terminal and the negative voltage terminal so as to use the connected positive voltage terminal or negative voltage terminal as a communication terminal to implement transmission of a communication signal with the vaporizer, wherein the communication signal comprises a plurality of spike signals superimposed based on a corresponding working voltage the communication terminal needs to output or a pulse width modulation signal generated by modulating the corresponding working voltage the communication terminal needs to output.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of functional modules of a first embodiment of a battery assembly according to this application;

FIG. 2 is a schematic diagram of functional modules of a first embodiment of a vaporizer according to this application;

FIG. 3 is a schematic diagram of functional modules of an electronic vaporization device formed by connecting the battery assembly shown in FIG. 1 and the vaporizer shown in FIG. 2;

FIG. 4 is a first schematic diagram of a first communication signal or a second communication signal according to this application;

FIG. 5 is a second schematic diagram of a first communication signal or a second communication signal according to this application;

FIG. 6 is a third schematic diagram of a first communication signal or a second communication signal according to this application;

FIG. 7 is a fourth schematic diagram of a first communication signal or a second communication signal according to this application;

FIG. 8 is a fifth schematic diagram of a first communication signal or a second communication signal according to this application;

FIG. 9 is a sixth schematic diagram of a first communication signal or a second communication signal according to this application;

FIG. 10 is a schematic diagram of a circuit structure of a first embodiment of a battery assembly according to this application;

FIG. 11 is a schematic diagram of a circuit structure of a second embodiment of a battery assembly according to this application;

FIG. 12 is a schematic diagram of a circuit structure of a third embodiment of a battery assembly according to this application;

FIG. 13 is a seventh schematic diagram of a first communication signal or a second communication signal according to this application;

FIG. 14 is a schematic diagram of a circuit structure of a fourth embodiment of a battery assembly according to this application;

FIG. 15 is an eighth schematic diagram of a first communication signal or a second communication signal according to this application;

FIG. 16 is a schematic diagram of a first equivalent structure of a second switch or a third switch according to this application;

FIG. 17 is a schematic diagram of a second equivalent structure of a second switch or a third switch according to this application;

FIG. 18 is a schematic diagram of a circuit structure of a first embodiment of a vaporizer according to this application;

FIG. 19 is a schematic diagram of a circuit structure of another embodiment of a vaporizer according to this application;

FIG. 20 is a schematic diagram of a circuit structure of a first embodiment of an electronic vaporization device according to this application;

FIG. 21 is a schematic diagram of a circuit structure of a second embodiment of an electronic vaporization device according to this application;

FIG. 22 is a schematic diagram of a circuit structure of a third embodiment of an electronic vaporization device according to this application; and

FIG. 23 is a schematic diagram of a circuit structure of a fourth embodiment of an electronic vaporization device according to this application.

### DETAILED DESCRIPTION

In an embodiment, the present invention provides a battery assembly, a vaporizer, and an electronic vaporization device, which can generate a communication signal with a plurality of spike signals or a communication signal generating a pulse width modulation signal, to implement communication between the battery assembly and the vaporizer through the communication signal, so that interference of an external signal is reduced.

In an embodiment, the present invention provides a positive voltage terminal and a negative voltage terminal, where a battery assembly is connected to a vaporizer by the positive voltage terminal and the negative voltage terminal to supply power to the vaporizer; and a control circuit, connected to at least one of the positive voltage terminal and the negative voltage terminal, to use the connected positive voltage terminal or negative voltage terminal as a communication terminal to implement transmission of a communication signal with the vaporizer, where the communication signal is a plurality of spike signals superimposed on the basis of a corresponding working voltage that the communication terminal needs to output or a pulse width modulation signal generated by modulating the corresponding working voltage that the communication terminal needs to output.

The positive voltage terminal is used as the communication terminal; the communication signal includes a first communication signal and a second communication signal, the first communication signal is a communication signal sent by the control circuit to the vaporizer through the communication terminal, and the second communication signal is a communication signal that is acquired by the control circuit through the communication terminal and that is fed back by the vaporizer; the first communication signal includes a plurality of first spike signals superimposed on the basis of the corresponding working voltage that the positive voltage terminal used as the communication terminal needs to output, or a first pulse width modulation signal generated by modulating the corresponding working voltage that the positive voltage terminal used as the communication terminal needs to output, the plurality of first spike signals are used for transferring a digital communication signal, or a logic high level in the first pulse width modulation signal corresponds to the corresponding working voltage that the positive voltage terminal needs to output, and a logic low level pulse corresponding to a logic low level in the first pulse width modulation signal is used for transferring a digital communication signal; and the second communication signal includes a plurality of second spike signals that are fed back and superimposed by the vaporizer on the basis of the corresponding working voltage that the positive voltage terminal used as the communication terminal needs to output, and the fed back plurality of second spike signals are used for transferring a digital communication signal.

Time intervals between two adjacent first spike signals, two adjacent logic low level pulses, and/or two adjacent second spike signals respectively represent different logic data values; or quantity values of the first spike signals, the logic low level pulses, and/or the second spike signals within a preset time period respectively represent different logic data values.

The time intervals between two adjacent first spike signals, two adjacent logic low level pulses, and/or two adjacent second spike signals satisfy a first preset time interval, to represent a logic data value “00”; the time intervals between two adjacent first spike signals, two adjacent logic low level pulses, and/or two adjacent second spike signals satisfy a second preset time interval, and there are an odd number of second preset time intervals, to represent a logic data value “01”; and the time intervals between two adjacent first spike signals, two adjacent logic low level pulses, and/or two adjacent second spike signals satisfy the second preset time interval, and there are an even number of second preset time intervals, to represent a logic data value “0”. The time intervals between two adjacent first spike signals, two adjacent logic low level pulses, and/or two adjacent second spike signals satisfy a third preset time interval, to represent a logic data value “1”.

A ratio of the first preset time interval, the second preset time interval, and the third preset time interval is 2:1.5:1.

N^{th} time intervals between two adjacent first spike signals, two adjacent logic low level pulses, and/or two adjacent second spike signals satisfy a customized fourth preset time interval corresponding to an N^{th} data bit of the communication signal, to represent a logic data value “0”; N^{th} time intervals between two adjacent first spike signals, two adjacent logic low level pulses, and/or two adjacent second spike signals satisfy a customized fifth preset time interval corresponding to an N^{th} data bit of the communication signal, to represent a logic data value “1”; fourth preset time intervals of any two data bits of the communication signal are equal or not equal; and fifth preset time intervals of any two data bits of the communication signal are equal or not equal.

The quantity values of the first spike signals, the logic low level pulses, and/or the second spike signals within the preset time period satisfy a preset first quantity range, to represent a logic data value “0”; and the quantity values of the first spike signals, the logic low level pulses, and/or the second spike signals within the preset time period satisfy a preset second quantity range, to represent a logic data value “1”.

The control circuit includes a controller and a first switch. The controller includes a first control terminal. The first switch is connected to a voltage source, the first control terminal of the controller, and the communication terminal, to connect/disconnect a path between the voltage source and the communication terminal according to on/off of a first control signal of the first control terminal, for the controller to use the first switch to enable the voltage source to provide the corresponding working voltage to the communication terminal.

The first communication signal is the first pulse width modulation signal; and the first control signal is a second pulse width modulation signal, for turning on/off the first switch, to modulate the corresponding working voltage into the first pulse width modulation signal.

Duration of the logic low level pulse in the first pulse width modulation signal is shorter than a maximum working time independently maintained by the vaporizer, and the maximum working time independently maintained by the vaporizer is a maximum working time that can be independently maintained with electrical energy stored after the vaporizer receives the corresponding working voltage.

The first communication signal is the plurality of first spike signals superimposed on the basis of the corresponding working voltage that the communication terminal needs to output; and the control circuit further includes: a second switch, connected to the communication terminal, where in a state that the first switch is turned on to enable the voltage source to provide the corresponding working voltage to the communication terminal, the second switch is turned on/off to superimpose the first spike signals on the basis of the corresponding working voltage outputted by the communication terminal, to generate the first communication signal.

When the vaporizer is connected to the battery assembly, the control circuit is further configured to detect the second communication signal fed back on the communication terminal, the vaporizer includes a third switch connected to the communication terminal, and in a state that the first switch is turned on to enable the voltage source to provide the corresponding working voltage to the communication terminal, the third switch is turned on/off to superimpose the second spike signals on the basis of the corresponding working voltage outputted by the communication terminal, to generate the second communication signal.

The first spike signals or the second spike signals are upper spike signals or lower spike signals, the upper spike signals are first voltage burst signals formed in a direction less than the corresponding working voltage on the basis of the corresponding working voltage, and the lower spike signals are second voltage burst signals formed in a direction greater than the corresponding working voltage on the basis of the corresponding working voltage.

When the second switch or the third switch is switched from a first state to a second state, the first spike signals or the second spike signals are the lower spike signals; when the second switch or the third switch is switched from the second state to the first state, the first spike signals or the second spike signals are the upper spike signals; and the first state is one of an on state or an off state, and the second state is the other of the on state or the off state.

The second switch or the third switch is an N-type switching transistor. When the second switch or the third switch is switched from the off state to the on state, the first spike signals or the second spike signals are the lower spike signals; and when the second switch or the third switch is switched from the on state to the off state, the first spike signals or the second spike signals are the upper spike signals.

A minimum voltage value of the lower spike signal in the first communication signal is greater than a minimum working voltage of the vaporizer, for the battery assembly to supply power to the vaporizer through the first communication signal when the vaporizer is connected to the battery assembly for communication.

The second switch or the third switch is connected to a path of the communication terminal, and is connected in parallel to a first capacitor, to transfer the first spike signals or the second spike signals to the communication terminal through a bootstrap effect of the first capacitor, to keep a wire resistance of the path from consuming the first spike signals or the second spike signals.

The control circuit further includes: a communication signal sending unit, connected to the controller and the communication terminal, and the communication signal sending unit includes the second switch, for turning on/off the second switch under the control of the controller, to superimpose the first spike signals on the basis of the corresponding working voltage outputted by the communication terminal; or the controller includes: a communication signal output terminal, connected to the communication terminal, and the controller further includes the second switch, the second switch is connected to the communication terminal by the communication signal output terminal, and the controller controls on/off of the second switch, to superimpose, by using the communication signal output terminal, the first spike signals on the basis of the corresponding working voltage outputted by the communication terminal.

The control circuit further includes: a feedback signal receiving unit, connected to the controller and the communication terminal, to detect the second communication signal fed back on the communication terminal, and feed back the second communication signal to the controller, and the second communication signal is the second spike signals superimposed by the vaporizer, by controlling on/off of the third switch, on the basis of the corresponding working voltage outputted by the communication terminal; or the controller includes: a communication signal receiving terminal, connected to the communication terminal, to detect and receive the second communication signal fed back on the communication terminal, and the second communication signal is the second spike signals superimposed by the vaporizer, by controlling on/off of the third switch, on the basis of the corresponding working voltage outputted by the communication terminal.

To resolve the foregoing technical problem, a second technical solution provided in this application is to provide a vaporizer, including a first connecting terminal and a second connecting terminal, respectively configured to connect to a battery assembly to receive electrical energy provided by the battery assembly; and a drive circuit, connected to the first connecting terminal and the second connecting terminal, where the drive circuit uses at least one of the first connecting terminal or the second connecting terminal as a communication terminal to implement transmission of a communication signal with the battery assembly, where the communication signal is a plurality of spike signals superimposed on the basis of a corresponding working voltage that the communication terminal needs to output or a pulse width modulation signal generated by modulating the corresponding working voltage that the communication terminal needs to output.

The battery assembly uses a positive voltage terminal as the communication terminal of the battery assembly, and the vaporizer uses the first connecting terminal or the second connecting terminal connected to the positive voltage terminal as the communication terminal, to implement communication with the battery assembly; the communication signal includes a first communication signal and a second communication signal, the first communication signal is a communication signal sent by a control circuit to the vaporizer through the communication terminal, and the second communication signal is a communication signal that is acquired by the control circuit through the communication terminal and that is fed back by the vaporizer; the first communication signal includes a plurality of first spike signals superimposed on the basis of the corresponding working voltage that the positive voltage terminal used as the communication terminal needs to output, or a first pulse width modulation signal generated by modulating the corresponding working voltage that the positive voltage terminal used as the communication terminal needs to output, the plurality of first spike signals are used for transferring a digital communication signal, or a logic high level in the first pulse width modulation signal corresponds to the corresponding working voltage that the positive voltage terminal needs to output, and a logic low level pulse corresponding to a logic low level in the first pulse width modulation signal is used for transferring a digital communication signal; and the second communication signal includes a plurality of second spike signals that are fed back and superimposed by the vaporizer on the basis of the corresponding working voltage that the positive voltage terminal used as the communication terminal needs to output, and the fed back plurality of second spike signals are used for transferring a digital communication signal.

The drive circuit further includes: a communication signal receiving unit, connected to the communication terminal, to detect the first communication signal transferred from the communication terminal of the battery assembly; and a communication signal feedback unit, connected to the communication terminal, to use the communication terminal to generate the second communication signal on the communication terminal of the battery assembly.

The communication signal feedback unit includes: a third switch, connected to the communication terminal, to use the communication terminal to connect to the communication terminal of the battery assembly, to feed back the second communication signal on the communication terminal of the battery assembly through on/off of the third switch.

The drive circuit further includes: a signal forward/reverse switching unit, connected to the first connecting terminal and the second connecting terminal, to enable the vaporizer to be forwardly or reversely connected to the battery assembly.

To resolve the foregoing technical problem, a third technical solution provided in this application is to provide an electronic vaporization device, including: a battery assembly, including the battery assembly according to any one of the foregoing; and a vaporizer, including the vaporizer according to any one of the foregoing.

Different from the case in the related art, beneficial effects of this application are as follows: A control circuit is disposed in the battery assembly in this application. The control circuit includes a positive voltage terminal. The positive voltage terminal is used as a communication terminal to transmit a first communication signal to a vaporizer and receive a second communication signal transmitted by the vaporizer. The first communication signal includes a plurality of pike signals or the first communication signal is a pulse width modulation signal, and the second communication signal includes a plurality of pike signals, so that interference of an external signal can be effectively reduced, to implement better communication between the battery assembly and the vaporizer.

The technical solutions in embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

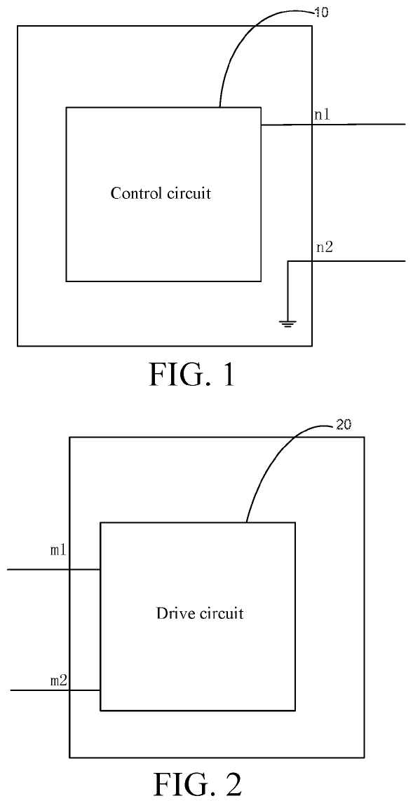

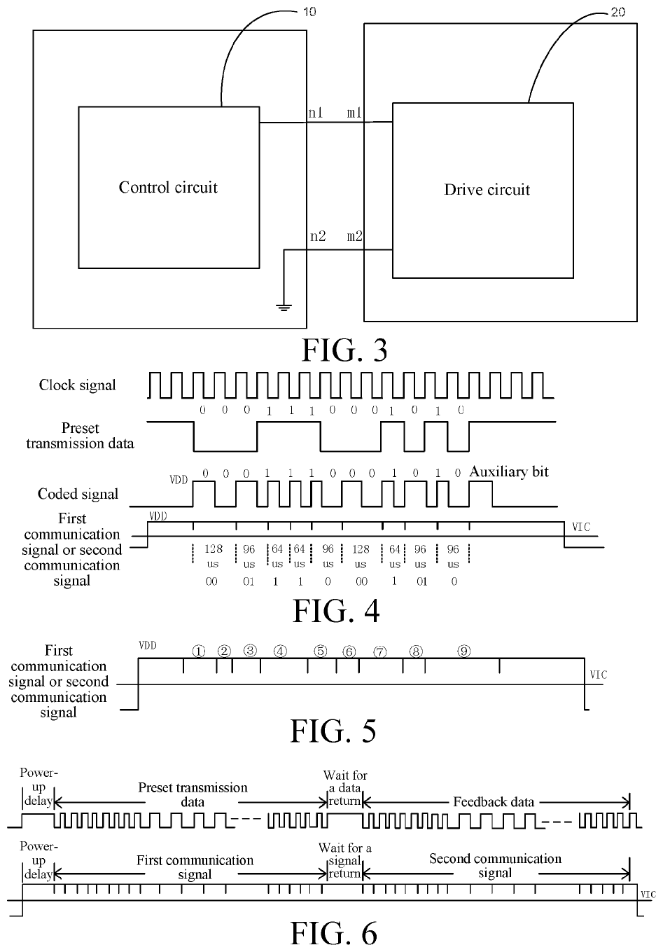

FIG. 1 is a schematic diagram of functional modules of a first embodiment of a battery assembly according to this application. FIG. 2 is a schematic diagram of functions of a first embodiment of a vaporizer according to this application. Specifically, the battery assembly includes a positive voltage terminal n1, a negative voltage terminal n2, and a control circuit 10. The vaporizer includes a first connecting terminal m1, a second connecting terminal m2, and a drive circuit 20. When the vaporizer is inserted into the battery assembly to be connected to the control circuit 10, the positive voltage terminal n1 of the battery assembly is connected to the first connecting terminal m1 of the vaporizer, and the negative voltage terminal n2 of the battery assembly is connected to the second connecting terminal m2 of the vaporizer, to enable the battery assembly to supply power to the vaporizer. FIG. 3 is a diagram of functional modules of a first embodiment of an electronic vaporization device formed by connecting the battery assembly shown in FIG. 1 and the vaporizer shown in FIG. 2.

Referring to FIG. 3, to overcome an external signal and improve stability of a communication signal, in this application, the battery assembly is connected to the vaporizer by the positive voltage terminal n1 and the negative voltage terminal n2 to supply power to the vaporizer. The control circuit 10 is connected to at least one of the positive voltage terminal n1 and the negative voltage terminal n2, and uses the connected positive voltage terminal n1 or negative voltage terminal n2 as a communication terminal to implement transmission of a communication signal with the vaporizer. The communication signal is a plurality of spike signals superimposed on the basis of a corresponding working voltage that the communication terminal needs to output or a pulse width modulation signal generated by modulating the corresponding working voltage that the communication terminal needs to output.

Further, the positive voltage terminal n1 of the battery assembly is connected to the first connecting terminal m1 of the vaporizer, the negative voltage terminal n2 of the battery assembly is connected to the second connecting terminal m2 of the vaporizer, the battery assembly implements transmission of a first communication signal with the vaporizer through the positive voltage terminal n1, and the vaporizer implements transmission of a second communication signal with the battery assembly through the first connecting terminal m1. In this way, communication between the battery assembly and the vaporizer is implemented, to determine whether the battery assembly matches the vaporizer.

It may be understood that, in this embodiment, the control circuit 10 is connected to the positive voltage terminal n1, and the positive voltage terminal n1 is used as the communication terminal to implement transmission of a communication signal with the vaporizer. The communication signal includes a first communication signal and a second communication signal. The first communication signal is a communication signal sent by the control circuit 10 to the vaporizer through the communication terminal. The second communication signal is a communication signal that is acquired by the control circuit 10 through the communication terminal and that is fed back by the vaporizer.

The first communication signal includes a plurality of first spike signals superimposed on the basis of the corresponding working voltage that the positive voltage terminal n1 used as the communication terminal needs to output, or a first pulse width modulation signal generated by modulating the corresponding working voltage that the positive voltage terminal n1 used as the communication terminal needs to output. The plurality of first spike signals are used for transferring a digital communication signal, or a logic high level in the first pulse width modulation signal corresponds to the corresponding working voltage that the positive voltage terminal n1 needs to output, and a logic low level pulse corresponding to a logic low level in the first pulse width modulation signal is used for transferring a digital communication signal.

The second communication signal includes a plurality of second spike signals that are fed back and superimposed by the vaporizer on the basis of the corresponding working voltage that the positive voltage terminal n1 used as the communication terminal needs to output, and the fed back plurality of second spike signals are used for transferring a digital communication signal.

Specifically, in an embodiment, the first communication signal is a plurality of first spike signals superimposed on the basis of the corresponding working voltage outputted by the positive voltage terminal n1 used as the communication terminal, and the plurality of first spike signals are used for transferring a digital communication signal. The second communication signal is a plurality of second spike signals that are fed back and superimposed by the vaporizer on the basis of the corresponding working voltage that the positive voltage terminal n1 used as the communication terminal needs to output, and the plurality of second spike signals are used for transferring a digital communication signal.

For that the plurality of first spike signals are used for transferring a digital communication signal or that the plurality of second spike signals are used for transferring a digital communication signal, specific representation manners are as follows:

In the first case, referring to FIG. 4 and FIG. 5, time intervals between two adjacent first spike signals or two adjacent second spike signals respectively represent different logic data values. In the second case, referring to FIG. 6, quantity values of the first spike signals or the second spike signals within a preset time period respectively represent different logic data values.

Referring to FIG. 4, the first case is further described. The time intervals between two adjacent first spike signals or two adjacent second spike signals satisfy a first preset time interval, to represent a logic data value “00”; the time intervals between two adjacent first spike signals or two adjacent second spike signals satisfy a second preset time interval, and there are an odd number of second preset time intervals, to represent a logic data value “01”; the time intervals between two adjacent first spike signals or two adjacent second spike signals satisfy the second preset time interval, and there are an even number of second preset time intervals, to represent a logic data value “0”; and the time intervals between two adjacent first spike signals or two adjacent second spike signals satisfy a third preset time interval, to represent a logic data value “1”.

Further, a ratio of the first preset time interval, the second preset time interval, and the third preset time interval is 2:1.5:1.

Referring to FIG. 4 again, in this embodiment, the foregoing content is described by using data shown in the figure as an example. If the first preset time interval is 128 uS, the time intervals between two adjacent first spike signals or two adjacent second spike signals represent a logic data value “00”. If the second preset time interval is 96 uS and there are an odd number of second preset time intervals, the time intervals between two adjacent first spike signals or two adjacent second spike signals, to represent a logic data value “01”. If the second preset time interval is 96 uS and there are an even number of second preset time intervals, the time intervals between two adjacent first spike signals or two adjacent second spike signals, to represent a logic data value “0”. If the third preset time interval is 64 uS, the time intervals between two adjacent first spike signals or two adjacent second spike signals, to represent a logic data value “1”. 128:96:64 satisfies 2:1.5:1. With such a design, interference of an external signal on the first communication signal and the second communication signal can be effectively reduced, so that the battery assembly better matches the vaporizer.

Referring to FIG. 5, the first case is further described. Ni time intervals between two adjacent first spike signals or two adjacent second spike signals satisfy a customized fourth preset time interval corresponding to an N^{th} data bit of the communication signal, to represent a logic data value “0”; and N^{th} time intervals between two adjacent first spike signals or two adjacent second spike signals satisfy a customized fifth preset time interval corresponding to an Ni data bit of the communication signal, to represent a logic data value “1”.

Further, fourth preset time intervals of any two data bits of the communication signal are equal or not equal; and fifth preset time intervals of any two data bits of the communication signal are equal or not equal.

Referring to FIG. 5 again, in this embodiment, the foregoing content is described by using data shown in the figure as an example. It is customized that a preset time interval corresponding to the first data bit of a communication signal is 100 uS, to represent a logic data value “0”, and it is customized that a preset time interval corresponding to the first data bit of the communication signal is 200 uS, to represent a logic data value “1”.

It is customized that a preset time interval corresponding to the second data bit of the communication signal is 30 uS, to represent a logic data value “0”, and it is customized that a preset time interval corresponding to the second data bit of the communication signal is 60 uS, to represent a logic data value “1”.

It is customized that a preset time interval corresponding to the third data bit of the communication signal is 50 uS, to represent a logic data value “0”, and it is customized that a preset time interval corresponding to the third data bit of the communication signal is 10 uS, to represent a logic data value “1”.

It is customized that a preset time interval corresponding to the fourth data bit of the communication signal is 200 uS, to represent a logic data value “0”, and it is customized that a preset time interval corresponding to the fourth data bit of the communication signal is 600 uS, to represent a logic data value “1”. The rest is deduced by analogy for customization, until transmission data bits of the communication signal have been defined.

Assuming that preset transmission data of the communication signal is “0001110001010”, the first data bit is a logic data value “0”, and a time interval between the first two adjacent first spike signals or two adjacent second spike signals is 100 uS. The second data bit is a logic data value “0”, and a time interval between the first two adjacent first spike signals or two adjacent second spike signals is 30 uS. The third data bit is a logic data value “0”, and a time interval between the third two adjacent first spike signals or two adjacent second spike signals is 50 uS. The fourth data bit is a logic data value “1”, and a time interval between the fourth two adjacent first spike signals or two adjacent second spike signals is 600 uS. This is repeated until transmission data of the communication signal is completed. This manner can enable a user to perform customization, and interference of an external signal on the first communication signal and the second communication signal is effectively reduced, so that the battery assembly better matches the vaporizer. In addition, the safety of the communication between the battery assembly and the vaporizer is effectively improved.

Referring to FIG. 6, the second case is further described. The quantity value of the first spike signals or the second spike signals within the preset time period satisfies a preset first quantity range, to represent a logic data value “0”; and the quantity value of the first spike signals or the second spike signals within the preset time period satisfies a preset second quantity range, to represent a logic data value “1”.

In this embodiment, it may be understood that the foregoing content is described by using shown data as an example. Assuming that the preset transmission data of the communication signal is “0001110001010”, it is preset that a transmission time of each data bit is 100 uS. 80 spike signals are sent within this preset transmission time to represent a logic data value “0”. 40 spike signals are sent within this preset transmission time to represent a logic data value “1”. That is, during transmission of the first logic data value “0”, 80 spike signals are sent to the vaporizer or the battery assembly within 100 uS. During transmission of the second logic data value “0”, 80 spike signals are sent to the vaporizer or the battery assembly within 100 uS. The rest is deduced by analogy until the transmission data of the communication signal is completed.

In addition, in this embodiment, an error allowance of the quantity value of the received first spike signals or second spike signals is 20%. That is, when the vaporizer receives the first spike signals or the battery assembly receives the second spike signals, if 64 to 96 first spike signals or second spike signals are received, a data value “0” may still be represented, and if 32 to 48 first spike signals or second spike signals are received, a data value “1” may still be represented. With such a design, an anti-interference capability of communication signals of the battery assembly and the vaporizer is further improved, to implement communication between the battery assembly and the vaporizer.

Specifically, in another embodiment, the first communication signal is a first pulse width modulation signal. A logic high level in the first pulse width modulation signal corresponds to the corresponding working voltage that the positive voltage terminal n1 needs to output, and a logic low level pulse corresponding to a logic low level in the first pulse width modulation signal is used for transferring a digital communication signal. The second communication signal is a plurality of second spike signals that are fed back and superimposed by the vaporizer on the basis of the corresponding working voltage that the positive voltage terminal n1 used as the communication terminal needs to output, and the plurality of second spike signals are used for transferring a digital communication signal. It may be understood that the first communication signal may be a plurality of first spike signals superimposed on the basis of the corresponding working voltage outputted by the positive voltage terminal n1 used as the communication terminal, the plurality of first spike signals are used for transferring a digital communication signal, and the second communication signal is the foregoing first pulse width modulation signal.

That a logic low level pulse corresponding to a logic low level in the first pulse width modulation signal is used for transferring a digital communication signal is specifically:

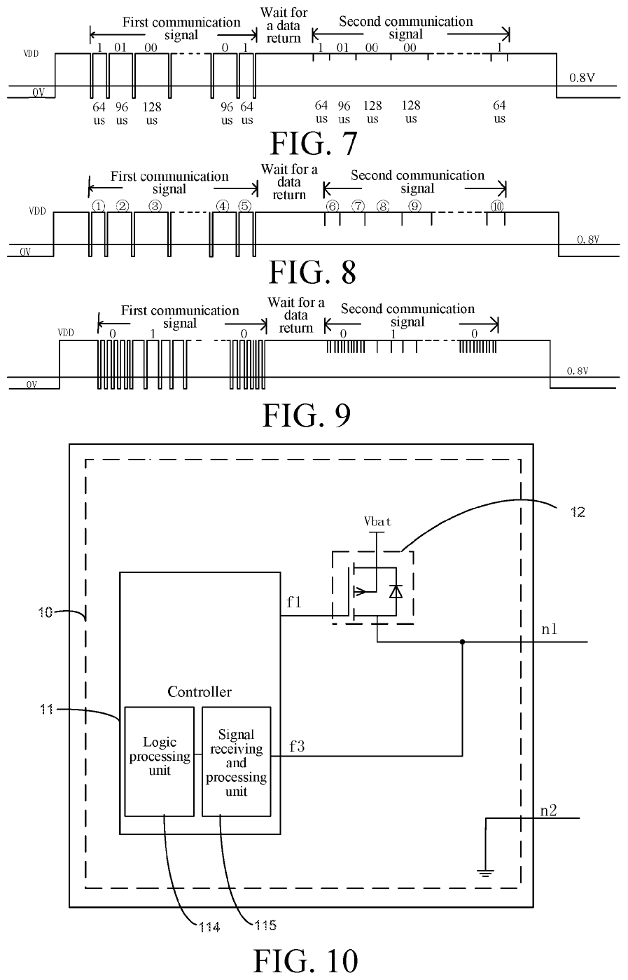

In the first case, referring to FIG. 7 and FIG. 8, time intervals between two adjacent logic low level pulses respectively represent different logic data values.

In the second case, referring to FIG. 9, quantity values of logic low level pulses within a preset time period respectively represent different logic data values.

Referring to FIG. 7, the first case is further described. The time intervals between two adjacent logic low level pulses satisfy a first preset time interval, to represent a logic data value “00”; the time intervals between two adjacent logic low level pulses satisfy a second preset time interval, and there are an odd number of second preset time intervals, to represent a logic data value “01”; the time intervals between two adjacent logic low level pulses satisfy the second preset time interval, and there are an even number of second preset time intervals, to represent a logic data value “0”; and The time intervals between two adjacent logic low level pulses satisfy a third preset time interval, to represent a logic data value “1”.

Further, a ratio of the first preset time interval, the second preset time interval, and the third preset time interval is 2:1.5:1.

Referring to FIG. 7 again, in this embodiment, the foregoing content is described by using data shown in the figure as an example. If the first preset time interval is 128 uS, the time intervals between two adjacent logic low level pulses represent a logic data value “00”. If the second preset time interval is 96 uS and there are an odd number of second preset time intervals, the time intervals between two adjacent logic low level pulses, to represent a logic data value “01”. If the second preset time interval is 96 uS and there are an even number of second preset time intervals, the time intervals between two adjacent logic low level pulses, to represent a logic data value “0”. If the third preset time interval is 64 uS, the time intervals between two adjacent logic low level pulses, to represent a logic data value “1”. 128:96:64 satisfies 2:1.5:1. With such a design, interference of an external signal on the first communication signal can be effectively reduced, so that the battery assembly better matches the vaporizer.

Referring to FIG. 8, the first case is further described. Ni time intervals between two adjacent logic low level pulses satisfy a customized fourth preset time interval corresponding to an N^{th} data bit of the communication signal, to represent a logic data value “0”; and Ni time intervals between two adjacent logic low level pulses satisfy a customized fifth preset time interval corresponding to an N^{th} data bit of the communication signal, to represent a logic data value “1”.

Further, fourth preset time intervals of any two data bits of the communication signal are equal or not equal; and fifth preset time intervals of any two data bits of the communication signal are equal or not equal.

Referring to FIG. 8 again, in this embodiment, the foregoing content is described by using data shown in the figure as an example. It is customized that a preset time interval corresponding to the first data bit of a communication signal is 100 uS, to represent a logic data value “0”, and it is customized that a preset time interval corresponding to the first data bit of the communication signal is 200 uS, to represent a logic data value “1”.

It is customized that a preset time interval corresponding to the second data bit of the communication signal is 30 uS, to represent a logic data value “0”, and it is customized that a preset time interval corresponding to the second data bit of the communication signal is 60 uS, to represent a logic data value “1”.

It is customized that a preset time interval corresponding to the third data bit of the communication signal is 50 uS, to represent a logic data value “0”, and it is customized that a preset time interval corresponding to the third data bit of the communication signal is 10 uS, to represent a logic data value “1”.

It is customized that a preset time interval corresponding to the fourth data bit of the communication signal is 200 uS, to represent a logic data value “0”, and it is customized that a preset time interval corresponding to the fourth data bit of the communication signal is 600 uS, to represent a logic data value “1”. The rest is deduced by analogy for customization, until transmission data bits of the communication signal have been defined.

Assuming that required transmission data of the communication signal is “0001110001010”, the first data bit is a logic data value “0”, and a time interval between the first two adjacent logic low level pulses is 100 uS; the second data bit is a logic data value “0”, and a time interval between the second two adjacent logic low level pulses is 30 uS; the third data bit is a logic data value “0”, and a time interval between the third two adjacent logic low level pulses is 50 uS; and the fourth data bit is a logic data value “1”, and a time interval between the first two adjacent logic low level pulses is 600 uS. This is repeated until transmission data of the communication signal is completed. This manner can enable a user to perform customization, and interference of an external signal on the first communication signal and the second communication signal is effectively reduced, so that the battery assembly better matches the vaporizer. In addition, the safety of the communication between the battery assembly and the vaporizer is effectively improved.

Referring to FIG. 9, the second case is further described. The quantity value of the logic low level pulses satisfies a preset first quantity range, to represent a logic data value “0”; and the quantity value of the logic low level pulses satisfies a preset second quantity range, to represent a logic data value “1”.

In this embodiment, it may be understood that the foregoing content is described by using shown data as an example. A transmission time of the communication signal is divided into N transmission time periods, and then a quantity value of the logic low level pulses in each transmission time period satisfies a preset second quantity range, to represent a logic data value “0” or “1”. Assuming that the first transmission time period is 5 ms, if the quantity value of the logic low level pulses is 10, a logic data value “1” is represented, and if the quantity value of the logic low level pulses is 20, a logic data value “0” is represented. Assuming that the second transmission time period is 8 ms, if the quantity value of the logic low level pulses is 30, a logic data value “1” is represented, and if the quantity value of the logic low level pulses is 5, a logic data value “0” is represented. The rest is deduced by analogy until transmission data of the communication signal is completed. With such a design, an anti-interference capability of communication signals of the battery assembly and the vaporizer is further improved, to implement communication between the battery assembly and the vaporizer.

That the second communication signal is a plurality of second spike signals that are fed back and superimposed by the vaporizer on the basis of the corresponding working voltage that the positive voltage terminal n1 used as the communication terminal needs to output, and the plurality of second spike signals are used for transferring a digital communication signal has been described in the embodiment of the first case. Details are not described again.

FIG. 10 is a schematic diagram of a circuit structure of a first embodiment of a battery assembly according to this application. The battery assembly includes a positive voltage terminal n1, a negative voltage terminal n2, and a control circuit 10. The control circuit 10 includes a controller 11 and a first switch 12. The controller 11 includes a first control terminal f1. The first switch 12 includes a first path end, a second path end, and a control end. The first path end of the first switch 12 is connected to a voltage source Vbat. The control end of the first switch 12 is connected to the first control terminal f1 of the controller 11. The second path end of the first switch 12 is connected to the positive voltage terminal n1 used as the communication terminal.

Specifically, the control terminal of the first switch 12 is turned on/off according to the first control signal of the first control terminal f1 of the controller 11, to connect/disconnect a path between the voltage source Vbat and the communication terminal, for the controller 11 to use the first switch 12 to enable the voltage source Vbat to provide the corresponding working voltage to the communication terminal.

Further, the positive voltage terminal n1 is configured to output the first communication signal, and the first communication signal is a first pulse width modulation signal. The first control terminal f1 is configured to output the first control signal, and the first control signal is a second pulse width modulation signal. The second pulse width modulation signal is used for turning on/off the first switch 12. In this way, the corresponding working voltage is modulated into the first pulse width modulation signal. A logic high level in the first pulse width modulation signal corresponds to the corresponding working voltage that the positive voltage terminal n1 needs to output, and a logic low level pulse corresponding to a logic low level in the first pulse width modulation signal is used for transferring a digital communication signal. A specific representation manner is the same as that in the foregoing another embodiment. Details are not described again.

The second pulse width modulation signal is a clock signal generated inside the controller 11 in an embodiment, and the controller 11 performs BMC coding on the preset transmission data in the controller 11 according to a clock signal to generate a coded signal. A rising edge or falling edge of the coded signal triggers the first switch 12 to enable the first switch 12 to be turned on/off, to generate the first pulse width modulation signal. Specifically, in this embodiment, the first switch 12 is an NMOS transistor. The first switch 12 is turned on to generate a logic high level signal, and the first switch 12 is turned off to generate a logic low level signal.

Further, a logic low level in the first pulse width modulation signal is used for transferring a digital communication signal, to implement a communication connection between the battery assembly and the vaporizer. In this implementation, when the communication connection is established between the battery assembly and the vaporizer, a voltage of the logic low level pulse in the first communication signal cannot exceed 0.8 V, so that the vaporizer can identify the logic low level in the first communication signal.

Further, duration of the logic low level pulse in the first pulse width modulation signal is shorter than a maximum working time independently maintained by the vaporizer, and the maximum working time independently maintained by the vaporizer is a maximum working time that can be independently maintained with electrical energy stored after the vaporizer receives the corresponding working voltage.

It may be understood that, referring to FIG. 7, FIG. 8, and FIG. 9, after the communication connection is established, the first communication signal provides a corresponding working voltage to the vaporizer. After receiving the corresponding working voltage, the vaporizer stores electrical energy of the corresponding working voltage. The stored electrical energy maintains a working state of the vaporizer within the duration that the first communication signal is a logic low level pulse. The corresponding working voltage is a voltage provided by the voltage source after a manual adjustment according to a working voltage of the control circuit 10 or the drive circuit 20. In this implementation, the maximum working time independently maintained by the vaporizer is shorter than 5 us, and the maximum working time independently maintained by the vaporizer is shorter than or equal to 2 us.

Further, the controller 11 further includes a communication signal receiving terminal f3, a signal receiving and processing unit 115, and a logic processing unit 114. The logic processing unit 114 is connected to the signal receiving and processing unit 115. The signal receiving and processing unit 115 is connected to the communication signal receiving terminal f3. The communication signal receiving terminal f3 is connected to the positive voltage terminal n1 used as the communication terminal, to detect the second communication signal fed back on the communication terminal. After being received by the signal receiving and processing unit 115, the detected second communication signal is transmitted to the logic processing unit 114, to identify the digital communication signal in the second communication signal. The signal receiving and processing unit 115 may be specifically an operational amplifier or a comparator.

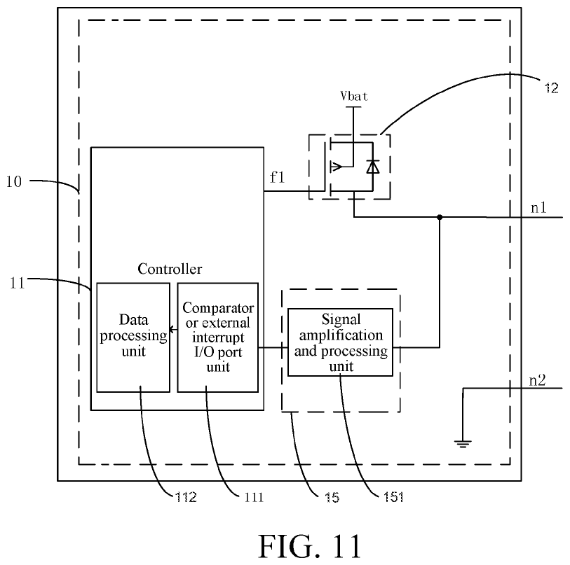

FIG. 11 is a schematic diagram of a circuit structure of a second embodiment of a battery assembly according to this application. Compared with the schematic structural diagram in the foregoing first embodiment, a distinguishing feature in this embodiment lies in that the control circuit 10 further includes a feedback signal receiving unit 15. The feedback signal receiving unit 15 includes a signal amplification and processing unit 151. The controller 11 includes a comparator or external interrupt I/O port unit 111 and a data processing unit 112. The data processing unit 112 is connected to the comparator or external interrupt I/O port unit 111. The comparator or external interrupt I/O port unit 111 is connected to the signal amplification and processing unit 151 in the feedback signal receiving unit 15. The feedback signal receiving unit 15 is connected to the positive voltage terminal n1 used as the communication terminal.

It is specifically understood that the feedback signal receiving unit 15 detects, through the positive voltage terminal n1 used as the communication terminal, the second communication signal fed back on the communication terminal. After being amplified by the signal amplification and processing unit 151 in the feedback signal receiving unit 15, the detected second communication signal is transmitted to the data processing unit 112, to identify the digital communication signal in the second communication signal.

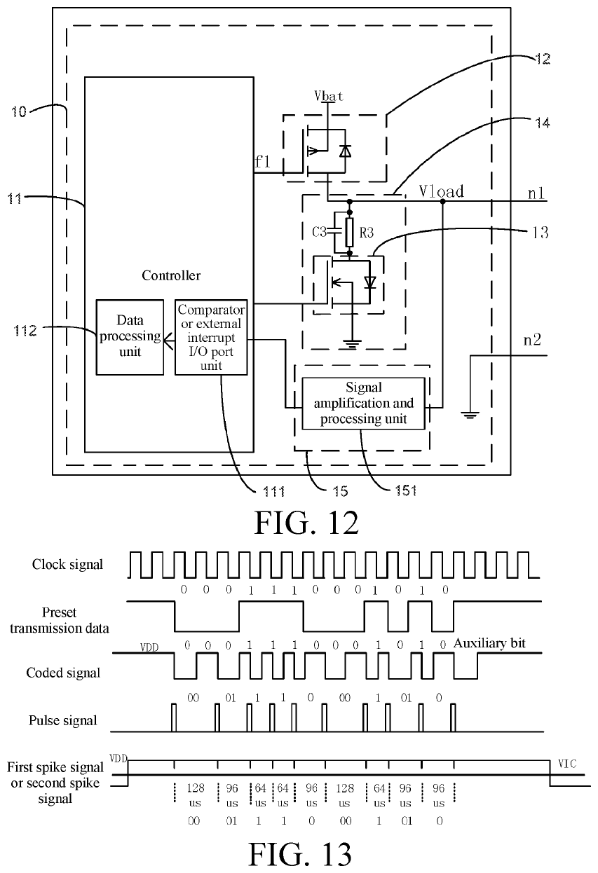

FIG. 12 is a schematic diagram of a circuit structure of a third embodiment of a battery assembly according to this application. The battery assembly includes a positive voltage terminal n1, a negative voltage terminal n2, and a control circuit 10. The control circuit 10 includes a controller 11 and a first switch 12. The controller 11 includes a first control terminal f1. The first switch 12 includes a first path end, a second path end, and a control end. The first path end of the first switch 12 is connected to a voltage source Vbat. The control end of the first switch 12 is connected to the first control terminal f1 of the controller 11. The second path end of the first switch 12 is connected to the communication terminal. Specifically, the control terminal of the first switch 12 is turned on/off according to the first control signal of the first control terminal f1 of the controller 11, to connect/disconnect a path between the voltage source Vbat and the communication terminal, for the controller 11 to use the first switch 12 to enable the voltage source Vbat to provide the corresponding working voltage to the communication terminal.

Further, the control circuit 10 further includes a communication signal sending unit 14 and a feedback signal receiving unit 15. The communication signal sending unit 14 includes a second switch 13, for turning on/off the second switch 13 under the control of the controller 11, to superimpose the first spike signals on the basis of the corresponding working voltage outputted by the positive voltage terminal n1 used as the communication terminal. Specifically, the second switch 13 is connected to the communication terminal, where in a state that the first switch 12 is turned on to enable the voltage source Vbat to provide the corresponding working voltage to the communication terminal, the second switch 13 is turned on/off to superimpose the first spike signals on the basis of the corresponding working voltage outputted by the communication terminal, to generate the first communication signal.

Further, the communication signal sending unit 14 further includes a resistor R3 and a first capacitor C3. The resistor R3 includes a first terminal and a second terminal. The first capacitor C3 includes a first terminal and a second terminal. The second switch 13 includes a first path end, a second path end, and a control end.

Specifically, the first terminal of the resistor R3 is connected to the first terminal of the first capacitor C3 and the positive voltage terminal n1 used as the communication terminal. The second terminal of the resistor R3 is connected to the second terminal of the first capacitor C3 and the first path end of the second switch 13. The second path end of the second switch 13 is grounded. The control end of the second switch 13 is connected to the controller 11. The second switch 13 is connected to a path of the communication terminal by the resistor R3, and is connected in parallel to the first capacitor C3, to transfer the first spike signals to the communication terminal through a bootstrap effect of the first capacitor C3, to keep a wire resistance of the path from consuming the first spike signals.

Specifically, when the second switch 13 is switched from a first state to a second state, the first spike signals are the lower spike signals; and when the second switch 13 is switched from the second state to the first state, the first spike signals are the upper spike signals. If the first state is an on state, the second state is an off state. If the first state is an off state, the second state is an on state.

Specifically, in this embodiment, the second switch 13 is an N-type switching transistor. When the second switch 13 is switched from an off state to an on state, the first spike signals are the lower spike signals; and when the second switch 13 is switched from the on state to the off state, the first spike signals are the upper spike signals.

Further, the feedback signal receiving unit 15 is connected to the controller 11 and the positive voltage terminal n1 used as the communication terminal, to detect the second communication signal fed back on the communication terminal, and feed back the second communication signal to the controller 11. In a state that the first switch 12 is turned on to enable the voltage source Vbat to provide the corresponding working voltage to the communication terminal, the second communication signal is a second spike signal that is superimposed on the basis of the corresponding working voltage outputted by the communication terminal and that is used by the vaporizer to control on/off of a third switch 23 in the vaporizer. Specifically, the feedback signal receiving unit 15 includes a signal amplification and processing unit 151, to amplify the detected second communication signal fed back on the communication terminal and transmit the amplified signal to the controller 11.

Further, the controller 11 includes a comparator or external interrupt I/O port unit 111 and a data processing unit 112. The data processing unit 112 is connected to the comparator or external interrupt I/O port unit 111. The comparator or external interrupt I/O port unit 111 is connected to the signal amplification and processing unit 151 in the feedback signal receiving unit 15. The feedback signal receiving unit 15 is connected to the positive voltage terminal n1 used as the communication terminal.

It is specifically understood that the feedback signal receiving unit 15 detects, through the positive voltage terminal n1 used as the communication terminal, the second communication signal fed back on the communication terminal. After being amplified by the signal amplification and processing unit 151 in the feedback signal receiving unit 15, the detected second communication signal is transmitted to the data processing unit 112, to identify the digital communication signal in the second communication signal.

In an embodiment, the foregoing content is further understood in combination with the waveform shown in FIG. 4. For example, the preset transmission data is “0001110001010”. A clock signal is generated inside the controller 11. The controller 11 performs BMC coding on the preset transmission data according to the clock signal to generate a coded signal. A plurality of coded signals are combined to form a transmission wave. The controller 11 outputs the transmission wave to the second switch 13, to enable a rising edge in the transmission wave to trigger on/off of the second switch 13, so that first spike signals are superimposed on the basis of the corresponding working voltage outputted by the communication terminal, to generate the first communication signal. A time interval between two adjacent first spike signals in the first communication signal represents a digital communication signal. A specific representation manner is described in the functional modules in the first embodiment. Details are not described again. In this embodiment, a clock speed of the clock signal is 32 uS, and a bit transmission speed is 64 uS.

Referring to FIG. 4 again, during BMC coding of the preset transmission data, when a data bit represents a logic data value “0”, a waveform of the data bit is not inverted in a time interval occupied by the waveform. When the data bit represents a logic data value “1”, a waveform of the data bit is inverted once in the time interval occupied by the waveform. In addition, a start level of a latter data bit in the coded signal is an opposite level of an end level of a former data bit.

Further, as shown in FIG. 4, during BMC coding of the preset transmission data, a rising edge of the waveform of the coded signal triggers on/off of the second switch 13. The last bit of the transmission data may be “0”, and there is a logic low level pulse in the transmission form. In this case, there is no falling edge in a transmission waveform, on/off of the second switch 13 cannot be triggered, and the preset transmission data is lost. To avoid this case, “0” is automatically padded as an auxiliary bit at the end of the coded signal, so that loss of data is avoided.

Further, as shown in FIG. 4, VIC represents a minimum working voltage of the drive circuit 20 of the vaporizer. A minimum voltage value of the lower spike signal in the first communication signal is greater than a minimum working voltage of the vaporizer, for the battery assembly to supply power to the vaporizer through the first communication signal when the vaporizer is connected to the battery assembly for communication.

In another embodiment, the foregoing content is further understood in combination with the waveform shown in FIG. 13. A difference between the waveform shown in FIG. 13 and the waveform shown in FIG. 4 lies in that after BMC coding is performed on the preset transmission data, a pulse signal with intervals is obtained inside the controller 11 according to a falling edge of the waveform after the BMC coding. The controller 11 outputs a pulse signal to turn on/off the second switch 13, so that first spike signals are superimposed on the basis of the corresponding working voltage outputted by the communication terminal, to generate the first communication signal. A time interval between two adjacent first spike signals in the first communication signal represents a digital communication signal.

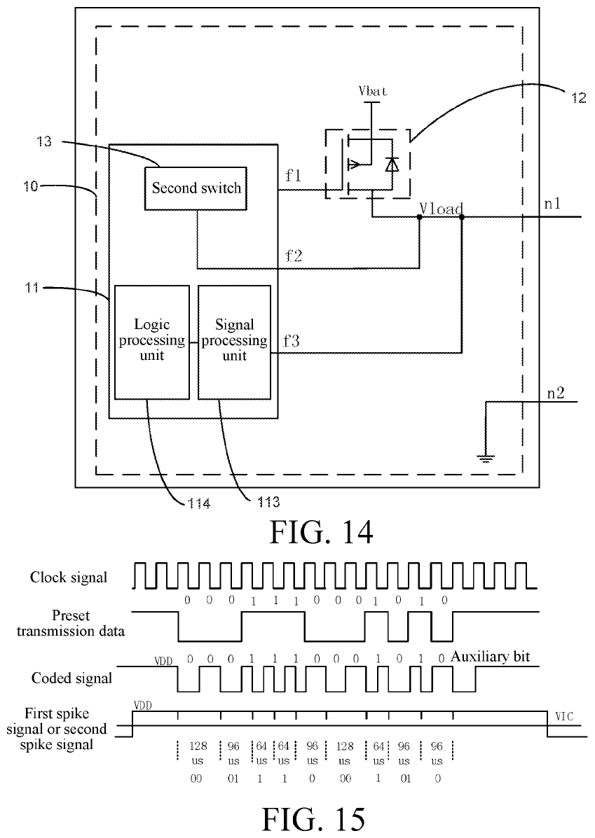

FIG. 14 is a schematic diagram of a circuit structure of a fourth embodiment of a battery assembly according to this application. The battery assembly includes a positive voltage terminal n1, a negative voltage terminal n2, and a control circuit 10. The control circuit 10 includes a controller 11 and a first switch 12. The controller 11 includes a first control terminal f1. The first switch 12 includes a first path end, a second path end, and a control end. The first path end of the first switch 12 is connected to a voltage source. The control end of the first switch 12 is connected to the first control terminal f1 of the controller 11. The second path end of the first switch 12 is connected to the communication terminal. Specifically, the control terminal of the first switch 12 is turned on/off according to the first control signal of the first control terminal f1 of the controller 11, to connect/disconnect a path between the voltage source and the communication terminal, for the controller 11 to use the first switch 12 to enable the voltage source to provide the corresponding working voltage to the communication terminal. Further, the controller 11 further includes a second switch 13, a communication signal output terminal f2, and a communication signal output terminal f3. The second switch 13 is connected to the positive voltage terminal n1 used as the communication terminal by the communication signal output terminal f2, where in a state that the first switch 12 is turned on to enable the voltage source Vbat to provide the corresponding working voltage to the communication terminal, the controller 11 controls on/off of the second switch 13 to superimpose the first spike signals on the basis of the corresponding working voltage outputted by the communication terminal, to generate the first communication signal.

The communication signal receiving terminal f3 is connected to the positive voltage terminal n1 used as the communication terminal, and is configured to detect the second communication signal fed back on the communication terminal, and the second communication signal is the second spike signals superimposed by the vaporizer, by controlling on/off of the third switch 23, on the basis of the corresponding working voltage outputted by the communication terminal of the vaporizer. That is, the vaporizer includes the third switch 23 connected to the communication terminal. In a state that the first switch 12 is turned on to enable the voltage source to provide the corresponding working voltage to the communication terminal, the third switch 23 is turned on/off to superimpose the second spike signals on the basis of the corresponding working voltage outputted by the communication terminal, to generate the second communication signal.

For that the plurality of first spike signals or the plurality of second spike signals are used for transferring a digital communication signal, a specific representation manner has been described in the foregoing first embodiment. Details are not described again.

Further, the controller 11 further includes a signal processing unit 113, a logic processing unit 114, and a communication signal receiving terminal f3. The signal processing unit 113 is connected to the logic processing unit 114 and the communication signal receiving terminal f3. The communication signal receiving terminal f3 is connected to the positive voltage terminal n1 used as the communication terminal, to detect the second communication signal fed back on the communication terminal. After being received by the signal processing unit 113, the detected second communication signal is transmitted to the logic processing unit 114, to identify the digital communication signal in the second communication signal. The signal processing unit 113 may be specifically an operational amplifier or a comparator.

It may be understood that in a state that the first switch 12 is turned on to enable the voltage source to provide the corresponding working voltage to the communication terminal, the controller 11 controls on/off of the second switch 13, to superimpose the first spike signals on the basis of the corresponding working voltage outputted by the communication terminal, to generate the first communication signal. The communication signal receiving terminal f3 is connected to the positive voltage terminal n1 used as the communication terminal, to detect the second communication signal fed back on the communication terminal. After being received by the signal processing unit 113, the second communication signal is transmitted to the logic processing unit 114, to identify the digital communication signal in the second communication signal, thereby implementing a communication connection between the battery assembly and the vaporizer.

In an embodiment, the foregoing content is further understood in combination with the waveform shown in FIG. 15. A difference between the waveform shown in FIG. 15 and the waveform shown in FIG. 4 in the foregoing embodiment lies in that a falling edge in the transmission form triggers on/off the second switch 13 in the controller 11, so that first spike signals are superimposed on the basis of the corresponding working voltage outputted by the communication terminal, to generate the first communication signal. A time interval between two adjacent first spike signals in the first communication signal represents a digital communication signal. A specific representation manner is described in the functional modules in the first embodiment. Details are not described again. In this embodiment, a clock speed of the clock signal is 32 uS, and a bit transmission speed is 64 uS.

Specifically, referring to FIG. 15 again, in FIG. 15, VIC represents a minimum working voltage of the drive circuit 20 of the vaporizer. A minimum voltage value of the lower spike signal in the first communication signal is greater than a minimum working voltage of the vaporizer, for the battery assembly to supply power to the vaporizer through the first communication signal when the vaporizer is connected to the battery assembly for communication.

In an embodiment, the first spike signals in the first communication signal are upper spike signals or lower spike signals, the upper spike signals are first voltage burst signals formed in a direction less than the corresponding working voltage on the basis of the corresponding working voltage, and the lower spike signals are second voltage burst signals formed in a direction greater than the corresponding working voltage on the basis of the corresponding working voltage.

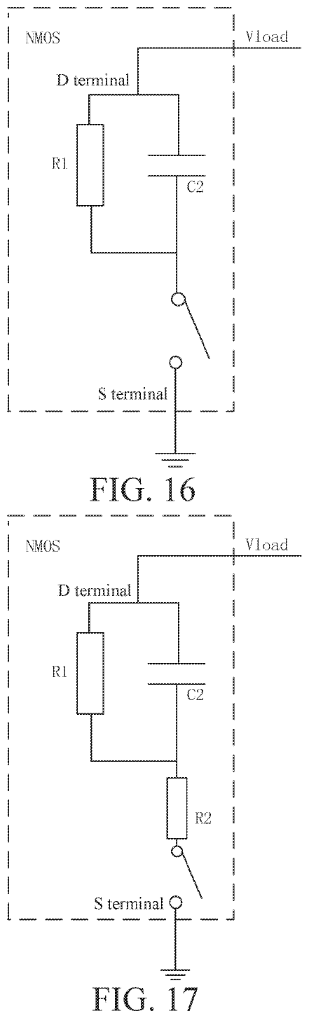

A generation principle of the first spike signals is described with reference to FIG. 16 and FIG. 17. Various types of circuits in the related art may generate spike signals. However, in this embodiment, an example in which the second switch 13 is an N-type switching transistor is used for description.

Referring to FIG. 16, an interelectrode equivalent capacitor C2 and an internal resistor R1 are connected in parallel inside an equivalent model of the second switch 13. The interelectrode equivalent capacitor C2 is located between a source and a drain (DS) of the second switch 13. When the second switch 13 is switched from an off state to an on state, the interelectrode equivalent capacitor C2 is instantaneously in a charging state (short-circuited), a D terminal voltage of the second switch 13 is in a logic low level. The interelectrode equivalent capacitor C2 of the second switch 13 is fully charged and is in a saturated on state. The D terminal voltage of the second switch 13 is in a saturated working state inside the internal resistor R1. A Vload terminal is in a logic high level. Therefore, when the second switch 13 is switched from the off state to the on state, an undershoot spike is formed at a D terminal of the second switch 13, so that the first spike signals or the second spike signals are the lower spike signals.

When the second switch 13 is in an on state, a current flows through the internal resistor R of the second switch 13 at a Vload terminal, and the interelectrode equivalent capacitor C2 of the second switch 13 has been fully charged. In this case, when the second switch 13 is switched from the on state to the off state, there is a current flowing at Vload on the internal resistor R1 of the second switch 13, and a current on the internal resistor R1 caused by discharging of the interelectrode equivalent capacitor C2 further needs to be superimposed, resulting in an increased voltage on the internal resistor R1, which reversely causes the Vload voltage to rise to form an overshoot spike. Therefore, when the second switch 13 is switched from the on state to the off state, an overshoot spike is formed on the D terminal of the second switch 13, to enable the first spike signals or the second spike signals to be the upper spike signals. Compared with FIG. 16, a distinguishing feature in FIG. 17 lies in that the equivalent capacitor C2 is connected to a divider resistor R3. The generation principle of the first spike signals by the equivalent capacitor is consistent with the foregoing principle in FIG. 15.

Further, because the undershoot spike is an instantaneous short circuit of the second switch 13, it is equivalent to that a resistance value of the internal resistor R1 is very small, and a voltage amplitude of the generated undershoot spike is higher than a voltage amplitude of the corresponding working voltage. The overshoot spike is that after the second switch 13 is turned on for a long time, the interelectrode equivalent capacitor C2 of the second switch 13 has been fully charged. After the second switch 13 is turned off, a resistance value is a resistance of the internal resistor R1 and a load Vload. Therefore, a voltage amplitude of the overshoot spike is lower than the voltage amplitude of the undershoot spike. Therefore, in this embodiment, a plurality of undershoot spike signals are used for the first communication signal to transfer a digital communication signal.

In addition, in this embodiment, the generation principle and related settings of the second spike signal in the second communication signal are consistent with the generation principle and related settings of the first spike signal in the first communication signal. For brevity, details are not described herein again.

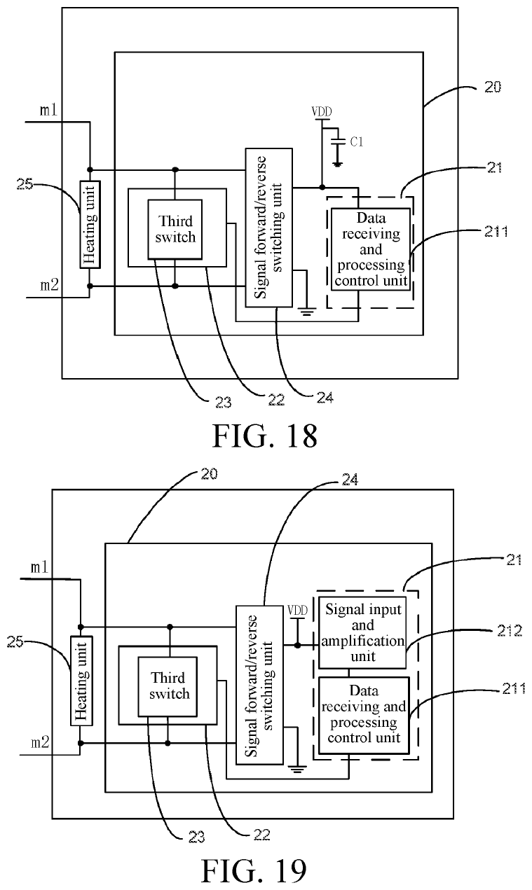

FIG. 18 is a schematic diagram of a circuit structure of a first embodiment of a vaporizer according to this application. The vaporizer includes a first connecting terminal m1, a second connecting terminal m2, and a drive circuit 20. A first connecting terminal m1 and a second connecting terminal m2 are respectively configured to connect to a battery assembly to receive electrical energy provided by the battery assembly. The drive circuit 20 is connected to the first connecting terminal m1 and the second connecting terminal m2. The drive circuit 20 uses at least one of the first connecting terminal m1 or the second connecting terminal m2 as a communication terminal to implement transmission of a communication signal with the battery assembly. The communication signal is the plurality of spike signals superimposed on the basis of the corresponding working voltage that the communication terminal needs to output.

Further, the battery assembly uses a positive voltage terminal n1 as the communication terminal of the battery assembly, and the vaporizer uses the first connecting terminal m1 or the second connecting terminal m2 connected to the positive voltage terminal n1 as the communication terminal, to implement communication with the battery assembly. The communication signal includes a first communication signal and a second communication signal. The first communication signal is a communication signal sent by the control circuit 10 to the vaporizer through the communication terminal. The second communication signal is a communication signal that is acquired by the control circuit 10 through the communication terminal and that is fed back by the vaporizer. In this embodiment, the first connecting terminal m1 is connected to the communication terminal of the battery assembly.

Further, the drive circuit 20 further includes a communication signal receiving unit 21 and a communication signal feedback unit 22. The communication signal receiving unit 21 is connected to the communication terminal, to detect the first communication signal transferred from the communication terminal of the battery assembly. The communication signal feedback unit 22 is connected to the communication terminal, to use the communication terminal to generate the second communication signal on the communication terminal of the battery assembly.

In an embodiment, as shown in FIG. 18, the communication signal receiving unit 21 includes a data receiving and processing control unit 211. The data receiving and processing control unit 211 is connected to the communication signal feedback unit 22 and the communication terminal. The data receiving and processing control unit 211 obtains the digital communication signal transferred in the first pulse width modulation signal. The communication signal feedback unit 22 controls on/off the third switch 23 according to a result of the digital communication signal that is transferred in the first pulse width modulation signal and that is obtained by the data receiving and processing control unit 211, to enable the communication terminal of the battery assembly to feed back the second communication signal.

In another implementation, as shown in FIG. 19, the communication signal receiving unit 21 includes a signal input and amplification unit 212 and a data receiving and processing control unit 211. The signal input and amplification unit 212 is connected to the communication terminal and the data receiving and processing control unit 211. The data receiving and processing control unit 211 is connected to the communication signal feedback unit 22. The signal input and amplification unit 212 receives and amplifies the first communication signal. The data receiving and processing control unit 211 obtains a digital signal represented by the plurality of spike signals in the first communication signal. The communication signal feedback unit 22 controls on/off of the third switch 23 according to a result of the digital signal that is obtained by the data receiving and processing control unit 211 and that is represented by the plurality of spike signals in the first communication signal, to enable the communication terminal of the battery assembly to feed back the second communication signal.

The communication signal feedback unit 22 includes a third switch 23. The third switch 23 is connected to the communication terminal, to use the communication terminal to connect to the communication terminal of the battery assembly, to feed back the second communication signal on the communication terminal of the battery assembly through on/off of the third switch 23. Specifically, the communication signal feedback unit 22 controls on/off of the third switch 23 according to a result of the digital communication signal that is obtained by the data receiving and processing control unit 211 and that is transferred in the first pulse width modulation signal or a result of the obtained digital signal that is represented by the plurality of spike signals in the first communication signal, to enable the communication terminal of the battery assembly to feed back the second communication signal.

In this embodiment, if the second communication signal fed back by the communication terminal of the battery assembly is the second spike signal, it is defined that the third switch 23 is an N-type switching transistor. When the third switch 23 is switched from an off state to an on state, the second spike signals are the lower spike signals; and when the third switch 23 is switched from the on state to the off state, the second spike signals are the upper spike signals.

Further, when a communication connection is established between the battery assembly and the vaporizer, the battery assembly supplies power to the vaporizer through the first communication signal. Therefore, a minimum voltage value of the lower spike signal in the first communication signal is greater than a minimum working voltage of the vaporizer, to ensure that when the vaporizer works, an electric power failure does not occur between the vaporizer and the battery assembly.

Further, the drive circuit 20 further includes a signal forward/reverse switching unit 24. The signal forward/reverse switching unit 24 is connected to the first connecting terminal m1 and the second connecting terminal m2, to enable the vaporizer to be forwardly or reversely connected to the battery assembly. Specifically, when the vaporizer is inserted into the battery assembly, regardless of whether the vaporizer is forwardly or reversely inserted, the battery assembly can supply power to the vaporizer through the signal forward/reverse switching unit 24.

Further, as shown in FIG. 18, the drive circuit 20 further includes an energy storage capacitor C1. The energy storage capacitor C1 is connected to the communication terminal of the battery assembly. After the communication connection is established between the battery assembly and the vaporizer, the first communication signal provides a corresponding working voltage to the vaporizer. After the vaporizer receives the corresponding working voltage, the energy storage capacitor C1 stores electrical energy of the corresponding working voltage, to maintain independent working of the vaporizer.

It is specifically understood that referring to FIG. 7, FIG. 8, and FIG. 9, when the communication connection is established between the battery assembly and the vaporizer, the first communication signal is the first pulse width modulation signal. A voltage of the logic low level pulse in the first pulse width modulation signal cannot exceed a maximum detection voltage of the vaporizer. In this embodiment, the maximum detection voltage of the vaporizer is 0.8 V, so that the vaporizer can identify the logic low level in the first pulse width modulation signal. After the communication connection is established, after the vaporizer receives the corresponding working voltage, the energy storage capacitor C1 stores electrical energy of the corresponding working voltage. Within the duration that the first pulse width modulation signal is in a logic low level pulse, the energy storage capacitor C1 discharges electricity to maintain the working state of the vaporizer, to receive a next logic low level pulse of the first pulse width modulation signal. In this embodiment, the maximum working time independently maintained by the vaporizer is shorter than 5 us. Preferably, the maximum working time independently maintained by the vaporizer is shorter than or equal to 2 us.

Further, the vaporizer further includes a heating unit 25. The heating unit 25 is connected to the first connecting terminal m1 and the second connecting terminal m2, and is configured to heat a to-be-vaporized substrate according to a heating signal sent by the battery assembly.

It may be understood that, as shown in FIG. 18 and FIG. 19, the drive circuit 20 may be an integrated chip (ASIC). A power supply signal VDD is a power supply inside a chip, and supplies power at two ends of a load.

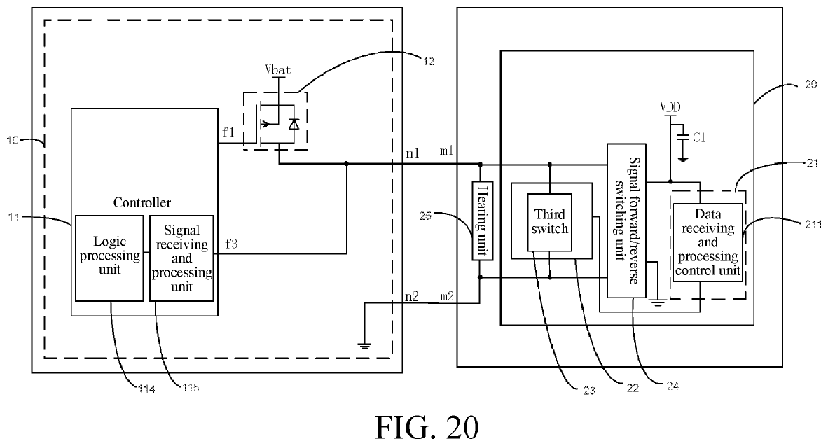

FIG. 20 is a schematic diagram of a circuit structure of a first embodiment of an electronic vaporization device according to this application. The electronic vaporization device includes a battery assembly and a vaporizer. The battery assembly includes the battery assembly in the structural schematic of the first embodiment of the foregoing battery assembly. The vaporizer includes the vaporizer in the structural schematic of the first embodiment of the foregoing vaporizer.

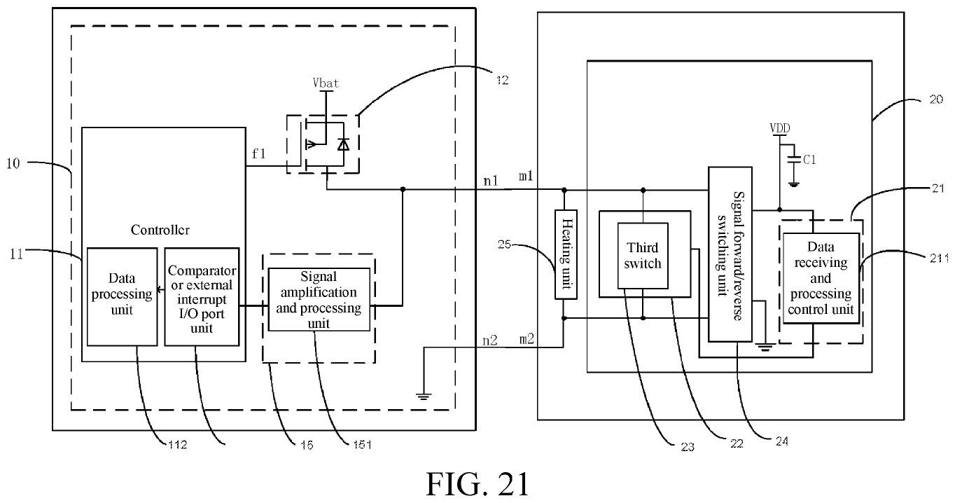

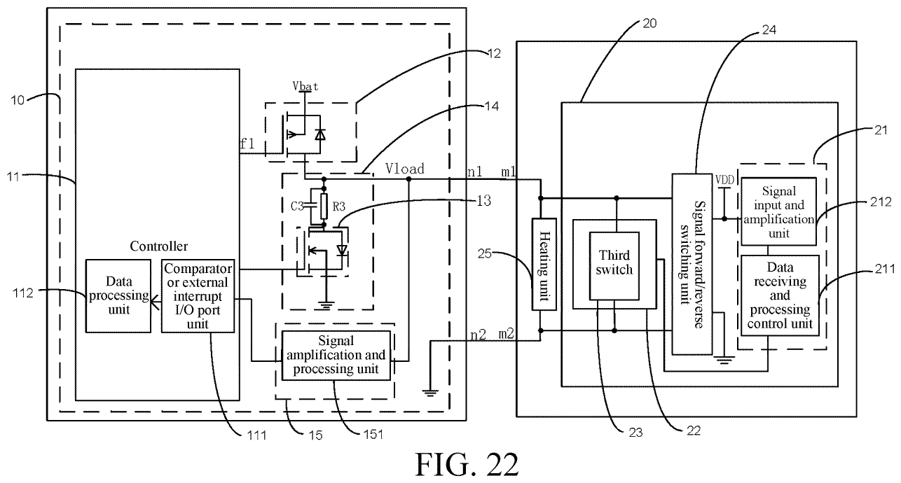

FIG. 21 is a schematic diagram of a circuit structure of a second embodiment of an electronic vaporization device according to this application. The electronic vaporization device includes a battery assembly and a vaporizer. The battery assembly includes the battery assembly in the structural schematic of the second embodiment of the foregoing battery assembly. The vaporizer includes the vaporizer in the structural schematic of the first embodiment of the foregoing vaporizer.

In the foregoing schematic structural diagram of the first embodiment of the electronic vaporization device and schematic structural diagram of the second embodiment of the electronic vaporization device, the battery assembly uses a positive voltage terminal n1 as the communication terminal of the battery assembly, and the vaporizer uses the first connecting terminal m1 connected to the positive voltage terminal n1 as the communication terminal, to implement communication with the battery assembly. The communication signal includes a first communication signal and a second communication signal. The first communication signal is a communication signal sent by the control circuit 10 to the vaporizer through the communication terminal. The second communication signal is a communication signal that is acquired by the control circuit 10 through the communication terminal and that is fed back by the vaporizer.

Specifically, the first communication signal is a first pulse width modulation signal generated by modulating the corresponding working voltage that the positive voltage terminal n1 used as the communication terminal needs to output. A logic high level in the first pulse width modulation signal corresponds to the corresponding working voltage that the positive voltage terminal n1 needs to output, and a logic low level pulse corresponding to a logic low level in the first pulse width modulation signal is used for transferring a digital communication signal. The second communication signal includes a plurality of second spike signals that are fed back and superimposed by the vaporizer on the basis of the corresponding working voltage that the positive voltage terminal n1 used as the communication terminal needs to output, and the fed back plurality of second spike signals are used for transferring a digital communication signal. For a specific representation manner of the first pulse width modulation signal and the second spike signals being used for transferring a digital communication signal. Details are not described again.

FIG. 22 is a schematic diagram of a circuit structure of a third embodiment of an electronic vaporization device according to this application. The battery assembly includes the battery assembly in the structural schematic of the third embodiment of the foregoing battery assembly. The vaporizer includes the vaporizer in the structural schematic of the second embodiment of the foregoing vaporizer.

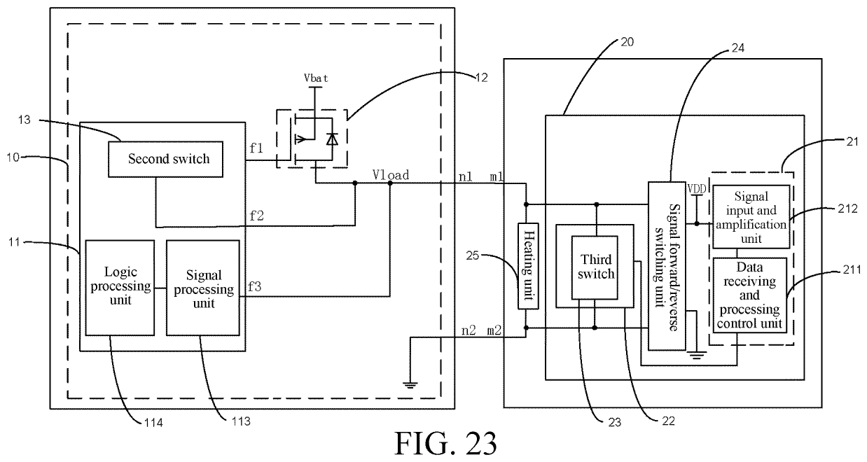

FIG. 23 is a schematic diagram of a circuit structure of a fourth embodiment of an electronic vaporization device according to this application. The battery assembly includes the battery assembly in the structural schematic of the fourth embodiment of the foregoing battery assembly. The vaporizer includes the vaporizer in the structural schematic of the second embodiment of the foregoing vaporizer.

In the foregoing schematic structural diagram of the third embodiment of the electronic vaporization device and schematic structural diagram of the fourth embodiment of the electronic vaporization device, the battery assembly uses a positive voltage terminal n1 as the communication terminal of the battery assembly, and the vaporizer uses the first connecting terminal m1 connected to the positive voltage terminal n1 as the communication terminal, to implement communication with the battery assembly. The communication signal includes a first communication signal and a second communication signal. The first communication signal is a communication signal sent by the control circuit 10 to the vaporizer through the communication terminal. The second communication signal is a communication signal that is acquired by the control circuit 10 through the communication terminal and that is fed back by the vaporizer.

The first communication signal includes a plurality of first spike signals superimposed on the basis of the corresponding working voltage that the positive voltage terminal n1 used as the communication terminal needs to output, and the plurality of first spike signals are used for transferring a digital communication signal. The second communication signal includes a plurality of second spike signals that are fed back and superimposed by the vaporizer on the basis of the corresponding working voltage that the positive voltage terminal n1 used as the communication terminal needs to output, and the fed back plurality of second spike signals are used for transferring a digital communication signal. For a specific representation manner of the first spike signal and the second spike signal being used for transferring a digital communication signal. Details are not described herein again. With such a design, in actual generation and use, anti-interference of communication signals can be improved. In addition, it is not necessary to add an amplification circuit to a vaporizer to process a spike signal, so that the size of the vaporizer is reduced, and productions costs of the electronic vaporization device is reduced.

The foregoing descriptions are merely implementations of this application, and the patent scope of this application is not limited thereto. All equivalent structure or process changes made according to the content of this specification and accompanying drawings in this application or by directly or indirectly applying this application in other related technical fields shall fall within the protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A battery assembly, comprising:
a positive voltage terminal and a negative voltage terminal, the battery assembly being connected to a vaporizer by the positive voltage terminal and the negative voltage terminal so as to supply power to the vaporizer; and
a control circuit connected to at least one of the positive voltage terminal and the negative voltage terminal so as to use the connected positive voltage terminal or negative voltage terminal as a communication terminal to implement transmission of a communication signal with the vaporizer,
wherein the communication signal comprises a plurality of spike signals superimposed based on a corresponding working voltage the communication terminal needs to output or a pulse width modulation signal generated by modulating the corresponding working voltage the communication terminal needs to output.

2. The battery assembly of claim 1, wherein the positive voltage terminal comprises the communication terminal, the communication signal comprises a first communication signal and a second communication signal, the first communication signal comprises a communication signal sent by the control circuit to the vaporizer through the communication terminal, and the second communication signal comprises a communication signal acquired by the control circuit through the communication terminal and fed back by the vaporizer,
wherein the first communication signal comprises a plurality of first spike signals superimposed based on the corresponding working voltage the positive voltage terminal comprising the communication terminal needs to output, or a first pulse width modulation signal generated by modulating the corresponding working voltage the positive voltage terminal comprising the communication terminal needs to output, the plurality of first spike signals being used to transfer a digital communication signal, or a logic high level in a first pulse width modulation signal corresponds to the corresponding working voltage the positive voltage terminal needs to output, and a logic low level pulse corresponding to a logic low level in the first pulse width modulation signal is used for transferring a digital communication signal, and
wherein the second communication signal comprises a plurality of second spike signals that are fed back and superimposed by the vaporizer based on the corresponding working voltage the positive voltage terminal used as the communication terminal needs to output, and the fed back plurality of second spike signals are used for transferring a digital communication signal.

3. The battery assembly of claim 2, wherein time intervals between two adjacent first spike signals, two adjacent logic low level pulses, and/or two adjacent second spike signals respectively represent different logic data values, or
wherein quantity values of the first spike signals, the logic low level pulses, and/or the second spike signals within a preset time period respectively represent different logic data values.

4. The battery assembly of claim 3, wherein the time intervals between two adjacent first spike signals, two adjacent logic low level pulses, and/or two adjacent second spike signals satisfy a first preset time interval, to represent a logic data value “00”,
wherein the time intervals between two adjacent first spike signals, two adjacent logic low level pulses, and/or two adjacent second spike signals satisfy a second preset time interval, and there are an odd number of second preset time intervals, to represent a logic data value “01”,
wherein the time intervals between two adjacent first spike signals, two adjacent logic low level pulses, and/or two adjacent second spike signals satisfy the second preset time interval, and there are an even number of second preset time intervals, to represent a logic data value “0”, and
wherein the time intervals between two adjacent first spike signals, two adjacent logic low level pulses, and/or two adjacent second spike signals satisfy a third preset time interval, to represent a logic data value “1”.

5. The battery assembly of claim 4, wherein a ratio of the first preset time interval, the second preset time interval, and the third preset time interval is 2:1.5:1.

6. The battery assembly of claim 3, wherein N^{th} time intervals between two adjacent first spike signals, two adjacent logic low level pulses, and/or two adjacent second spike signals satisfy a customized fourth preset time interval corresponding to an N^{th} data bit of the communication signal, to represent a logic data value “0”,
wherein N^{th} time intervals between two adjacent first spike signals, two adjacent logic low level pulses, and/or two adjacent second spike signals satisfy a customized fifth preset time interval corresponding to an N^{th} data bit of the communication signal, to represent a logic data value “1”, and
wherein fourth preset time intervals of any two data bits of the communication signal are equal or not equal; and fifth preset time intervals of any two data bits of the communication signal are equal or not equal.

7. The battery assembly of claim 3, wherein quantity values of the first spike signals, the logic low level pulses, and/or the second spike signals within the preset time period satisfy a preset first quantity range, to represent a logic data value “0”, and
wherein the quantity values of the first spike signals, the logic low level pulses, and/or the second spike signals within the preset time period satisfy a preset second quantity range, to represent a logic data value “1”.

8. The battery assembly of claim 2, wherein the control circuit comprises:
a controller comprising a first control terminal; and
a first switch connected to a voltage source, the first control terminal of the controller, and the communication terminal so as to connect/disconnect a path between the voltage source and the communication terminal according to on/off of a first control signal of the first control terminal, for the controller to use the first switch to enable the voltage source to provide the corresponding working voltage to the communication terminal.

9. The battery assembly of claim 8, wherein the first communication signal comprises the first pulse width modulation signal, and
wherein the first control signal comprises a second pulse width modulation signal, for turning on/off the first switch so as to modulate the corresponding working voltage into the first pulse width modulation signal.

10. The battery assembly of claim 9, wherein duration of the logic low level pulse in the first pulse width modulation signal is shorter than a maximum working time independently maintained by the vaporizer, and the maximum working time independently maintained by the vaporizer comprises a maximum working time independently maintainable with electrical energy stored after the vaporizer receives the corresponding working voltage.

11. The battery assembly of claim 8, wherein the first communication signal comprises the plurality of first spike signals superimposed based on the corresponding working voltage that the communication terminal needs to output, and
wherein the control circuit further comprises:
a second switch connected to the communication terminal, and
wherein, in a state in which the first switch is turned on to enable the voltage source to provide the corresponding working voltage to the communication terminal, the second switch is turned on/off to superimpose the first spike signals based on the corresponding working voltage outputted by the communication terminal so as to generate the first communication signal.

12. The battery assembly of claim 8, wherein, when the vaporizer is connected to the battery assembly, the control circuit is configured to detect the second communication signal fed back on the communication terminal, the vaporizer comprises a third switch connected to the communication terminal, and, in a state in which the first switch is turned on to enable the voltage source to provide the corresponding working voltage to the communication terminal, the third switch is turned on/off to superimpose the second spike signals based on the corresponding working voltage outputted by the communication terminal so as to generate the second communication signal.

13. The battery assembly of claim 11, wherein the first spike signals or the second spike signals comprise upper spike signals or lower spike signals, the upper spike signals comprise first voltage burst signals formed in a direction less than the corresponding working voltage based on the corresponding working voltage, and the lower spike signals comprise second voltage burst signals formed in a direction greater than the corresponding working voltage based on the corresponding working voltage.

14. The battery assembly of claim 13, wherein, when the second switch or the third switch is switched from a first state to a second state, the first spike signals or the second spike signals comprise the lower spike signals,
wherein, when the second switch or the third switch is switched from the second state to the first state, the first spike signals or the second spike signals comprise the upper spike signals, and
wherein the first state comprises one of an on state or an off state, and the second state comprises an other of the on state or the off state.

15. The battery assembly of claim 14, wherein the second switch or the third switch comprise an N-type switching transistor,
wherein, when the second switch or the third switch is switched from the off state to the on state, the first spike signals or the second spike signals comprise the lower spike signals, and
wherein, when the second switch or the third switch is switched from the on state to the off state, the first spike signals or the second spike signals comprise the upper spike signals.

16. The battery assembly of claim 15, wherein a minimum voltage value of the lower spike signal in the first communication signal is greater than a minimum working voltage of the vaporizer, for the battery assembly to supply power to the vaporizer through the first communication signal when the vaporizer is connected to the battery assembly for communication.

17. The battery assembly of claim 13, wherein the second switch or the third switch is connected to a path of the communication terminal and connected in parallel to a first capacitor so as to transfer the first spike signals or the second spike signals to the communication terminal through a bootstrap effect of the first capacitor so as to keep a wire resistance of the path from consuming the first spike signals or the second spike signals.

18. The battery assembly of claim 11, wherein the control circuit comprises:
a communication signal sending unit connected to the controller and the communication terminal, the communication signal sending unit comprising the second switch for turning on/off the second switch under the control of the controller so as to superimpose the first spike signals based on the corresponding working voltage outputted by the communication terminal, or
wherein the controller comprises:
a communication signal output terminal connected to the communication terminal; and
the second switch, the second switch being connected to the communication terminal by the communication signal output terminal, the controller being configured to control on/off of the second switch to superimpose, by using the communication signal output terminal, the first spike signals based on the corresponding working voltage outputted by the communication terminal.

19. The battery assembly of claim 12, wherein the control circuit comprises:
a feedback signal receiving unit connected to the controller and the communication terminal to detect the second communication signal fed back on the communication terminal, and feed back the second communication signal to the controller, the second communication signal comprising the second spike signals superimposed by the vaporizer, by controlling on/off of the third switch, based on the corresponding working voltage outputted by the communication terminal, or
wherein the controller comprises:
a communication signal receiving terminal connected to the communication terminal to detect and receive the second communication signal fed back on the communication terminal, the second communication signal comprising the second spike signals superimposed by the vaporizer, by controlling on/off of the third switch, based on the corresponding working voltage outputted by the communication terminal.

20. A vaporizer, comprising:
a first connecting terminal and a second connecting terminal respectively configured to connect to a battery assembly to receive electrical energy provided by the battery assembly; and
a drive circuit connected to the first connecting terminal and the second connecting terminal, the drive circuit using at least one of the first connecting terminal or the second connecting terminal as a communication terminal to implement transmission of a communication signal with the battery assembly,
wherein the communication signal comprises a plurality of spike signals superimposed based on a corresponding working voltage the communication terminal needs to output or a pulse width modulation signal generated by modulating the corresponding working voltage the communication terminal needs to output.

21. The vaporizer of claim 20, wherein the battery assembly uses a positive voltage terminal as the communication terminal of the battery assembly, and the vaporizer uses the first connecting terminal or the second connecting terminal connected to the positive voltage terminal as the communication terminal to implement communication with the battery assembly,
wherein the communication signal comprises a first communication signal and a second communication signal, the first communication signal being a communication signal sent by a control circuit to the vaporizer through the communication terminal, and the second communication signal being a communication signal that is acquired by the control circuit through the communication terminal and that is fed back by the vaporizer, and
wherein the first communication signal comprises a plurality of first spike signals superimposed based on the corresponding working voltage the positive voltage terminal used as the communication terminal needs to output, or a first pulse width modulation signal generated by modulating the corresponding working voltage the positive voltage terminal used as the communication terminal needs to output, the plurality of first spike signals being used for transferring a digital communication signal, or a logic high level in the first pulse width modulation signal corresponds to the corresponding working voltage the positive voltage terminal needs to output, and a logic low level pulse corresponding to a logic low level in the first pulse width modulation signal is used for transferring a digital communication signal, and
wherein the second communication signal comprises a plurality of second spike signals fed back and superimposed by the vaporizer based on the corresponding working voltage the positive voltage terminal used as the communication terminal needs to output, and the fed back plurality of second spike signals are used for transferring a digital communication signal.

22. The vaporizer of claim 21, wherein the drive circuit comprises:
a communication signal receiving unit connected to the communication terminal to detect the first communication signal transferred from the communication terminal of the battery assembly; and
a communication signal feedback unit connected to the communication terminal to use the communication terminal to generate the second communication signal on the communication terminal of the battery assembly.

23. The vaporizer of claim 22, wherein the communication signal feedback unit comprises:
a third switch connected to the communication terminal to use the communication terminal to connect to the communication terminal of the battery assembly to feed back the second communication signal on the communication terminal of the battery assembly through on/off of the third switch.

24. The vaporizer of claim 20, wherein the drive circuit comprises:
a signal forward/reverse switching unit connected to the first connecting terminal and the second connecting terminal to enable the vaporizer to be forwardly or reversely connected to the battery assembly.

25. An electronic vaporization device, comprising:
the battery assembly of claim 1; and
a vaporizer, comprising:
a first connecting terminal and a second connecting terminal respectively configured to connect to a battery assembly to receive electrical energy provided by the battery assembly; and
a drive circuit connected to the first connecting terminal and the second connecting terminal, the drive circuit using at least one of the first connecting terminal or the second connecting terminal as a communication terminal to implement transmission of a communication signal with the battery assembly,
wherein the communication signal comprises a plurality of spike signals superimposed based on a corresponding working voltage the communication terminal needs to output or a pulse width modulation signal generated by modulating the corresponding working voltage the communication terminal needs to output.
